(19) United States
(12) Patent Application Publication
(10) Pub. No.: US 2026/0323267 A1
(43) Pub. Date: Oct. 15, 2026

(54) BLUETOOTH LOW ENERGY ADVERTISING AND SCANNING

(71) Applicant: Cypress Semiconductor Corporation, San Jose, CA (US)

(72) Inventors: Victor ZHODZISHSKY, Potomac, MD (US); Narasimha Rao KONAIAH, San Diego, CA (US)

(73) Assignee: Cypress Semiconductor Corporation, San Jose, CA (US)

(21) Appl. No.: 19/317,139

(22) Filed: Sep. 3, 2025

Related U.S. Application Data
(60) Provisional application No. 63/786,203, filed on Apr. 9, 2025.

(51) Int. Cl. H04W 8/00; H04L 67/12; H04W 84/18

(52) U.S. Cl. CPC H04W 8/005; H04L 67/12; H04W 84/18

(57) ABSTRACT

A system includes a host controller and a plurality of Bluetooth low energy (BLE) anchors communicatively coupled to the host controller. The plurality of BLE anchors are organized in one or more groups of BLE anchors. BLE anchors in a group are synchronized and configured such that all BLE anchors in the group advertise sequentially jointly achieving a desired advertising interval. Additionally, BLE anchors in a group are configured such that all BLE anchors in the group scan sequentially jointly achieving a desired scan duty cycle.

### CROSS-REFERENCE TO RELATED APPLICATION

This application claims the benefit of U.S. Provisional Application No. 63/786,203, filed on Apr. 9, 2025, which is incorporated by reference herein.

### TECHNICAL FIELD

The present disclosure relates generally to Bluetooth low energy (BLE). More particularly, it relates to systems, vehicles, and methods for BLE advertising and scanning in access systems including multiple anchors.

### BACKGROUND

A typical vehicle access system with Bluetooth low energy (BLE) may include several BLE anchors that allow user devices (e.g., smart phones, smart watches, key fobs, etc.) to connect to the vehicle access system, authenticate with the vehicle access system, and participate in a keyless entry to the vehicle or various other vehicle control scenarios. In typical vehicle access implementations (e.g., based on the car connectivity consortium digital key (CCC DK) specification), some user devices (e.g., phones) may scan and the vehicle anchors may advertise to establish a connection. Some user devices (e.g., key fobs), however, cannot scan due to low power requirements for the user devices. Accordingly, these user devices may advertise and the vehicle anchors may scan to establish a connection. To establish a BLE connection, either the user device or the vehicle anchors need to advertise at a high duty cycle and/or the user device or the vehicle anchors need to scan at a high duty cycle. In a vehicle access use case, neither the vehicle nor the key fob knows when to increase the duty cycle. If a key fob advertises at a high duty cycle all the time, the battery life will be substantially shortened. If all the vehicle anchors advertise or scan all the time, the vehicle battery may be discharged more quickly.

For these and other reasons, a need exists for the claimed subject matter.

### SUMMARY

Some examples of the present disclosure relate to a system. The system includes a host controller and a plurality of Bluetooth low energy (BLE) anchors communicatively coupled to the host controller. The plurality of BLE anchors includes at least a first group of BLE anchors. The first group of BLE anchors each advertise sequentially according to a first anchor advertising interval. The first group of BLE anchors each scan sequentially according to a first anchor scan interval.

Other examples of the present disclosure relate to a vehicle. The vehicle includes a host controller and a plurality of Bluetooth low energy (BLE) anchors communicatively coupled to the host controller. The plurality of BLE anchors includes a central BLE anchor, a first group of BLE anchors, and a second group of BLE anchors. The first group of BLE anchors each advertise sequentially according to a first anchor advertising interval. The second group of BLE anchors each advertise sequentially according to a second anchor advertising interval.

Yet other examples of the present disclosure relate to a method. The method includes grouping a plurality of Bluetooth low energy (BLE) anchors into at least a first group of BLE anchors and a second group of BLE anchors. The method includes scheduling advertising among the first group of BLE anchors such that each BLE anchor of the first group advertises during a different portion of a first anchor advertising interval. The method includes scheduling advertising among the second group of BLE anchors such that each BLE anchor of the second group advertises during a different portion of a second anchor advertising interval.

### BRIEF DESCRIPTION OF THE DRAWINGS

FIGS. 1A and 1B are block diagrams illustrating example systems including Bluetooth low energy (BLE) anchors.

FIGS. 2A-2C are schematic diagrams illustrating example vehicles including BLE anchors.

FIG. 3 is a timing diagram illustrating an example method for a group of BLE anchors to each advertise sequentially according to an anchor advertising interval.

FIG. 4 is a timing diagram illustrating an example method for a group of BLE anchors to each scan sequentially according to an anchor scan interval.

FIGS. 5A-5C are flow diagrams illustrating example methods for operating systems including BLE anchors.

FIG. 6 is a block diagram illustrating an example BLE anchor.

FIG. 7 is a block diagram illustrating an example processing system for a host controller or central BLE anchor.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

In typical vehicle access systems, one Bluetooth low energy (BLE) anchor may be dedicated in the vehicle to perform advertising or scanning. If the BLE anchor is located inside the vehicle, the radio frequency (RF) propagation outside the vehicle is limited. If the BLE anchor is located on one side of the vehicle, the RF propagation is not optimal for a user possessing a connectable user device (e.g., smart phone, smart watch, key fob, etc.) approaching the vehicle from the opposite side of the vehicle. Therefore, original equipment manufacturers (OEMs) may install multiple BLE anchors around the vehicle. Advertising and scanning, however, by multiple BLE anchors may affect the battery life of the user device and/or the vehicle.

Accordingly, disclosed herein are systems, vehicles, and methods to enable multiple BLE anchors to efficiently perform BLE advertising and scanning. In this way, RF coverage may be improved while keeping power consumption low. To efficiently advertise and scan, the BLE anchors may be synchronized and advertising and scanning may be performed on a schedule. While one of the BLE anchors is scanning, other BLE anchors may be in a sleep state. The total scan duty cycle may reach as high as 100 percent allowing the fastest possible connection establishment between a BLE anchor and a user device. Advertising activity may be distributed among the BLE anchors to achieve a selected density of advertisements.

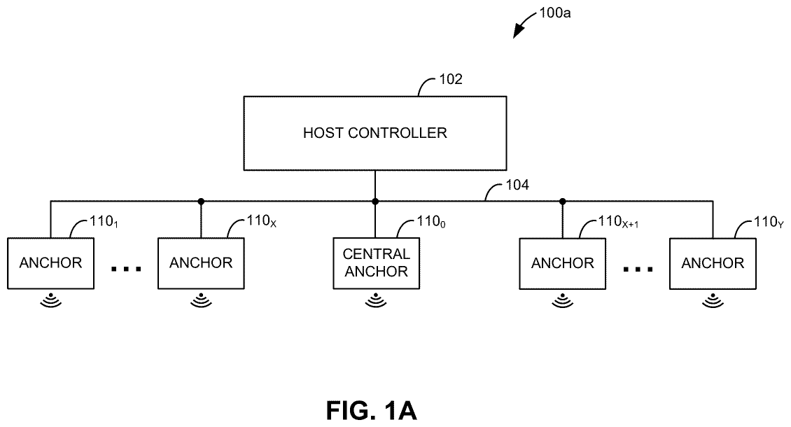

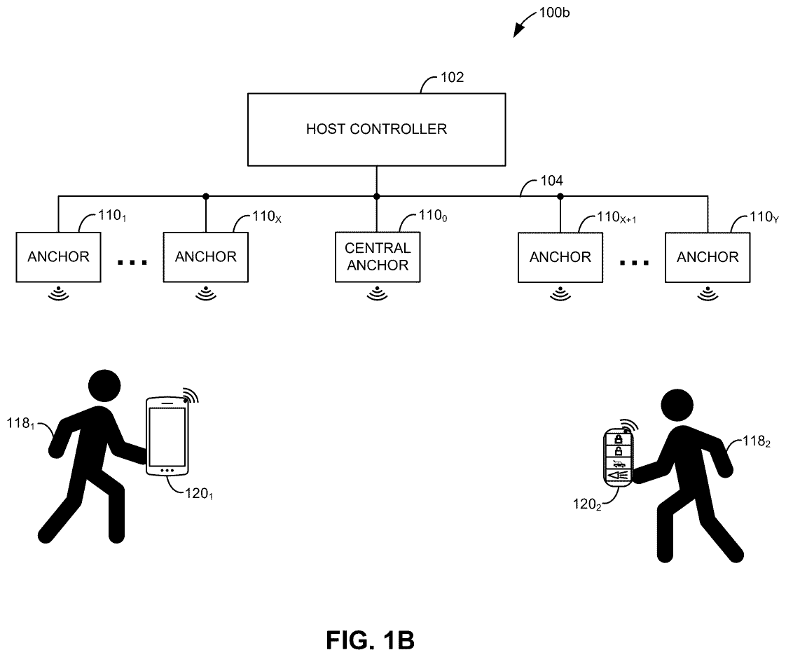

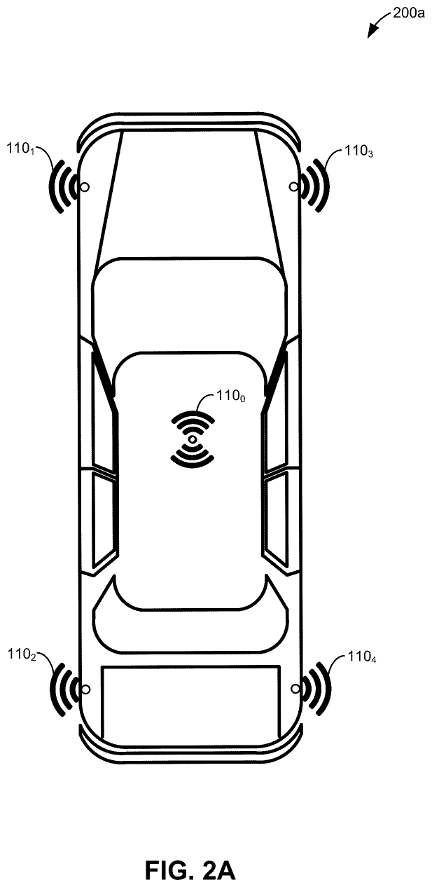

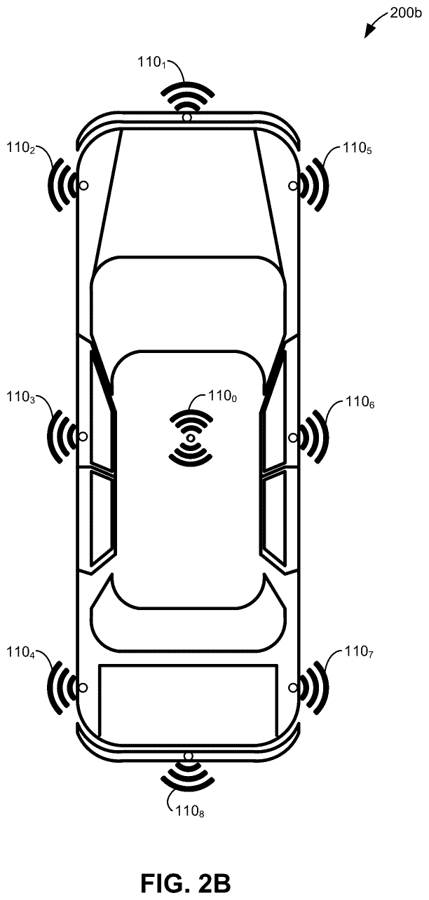

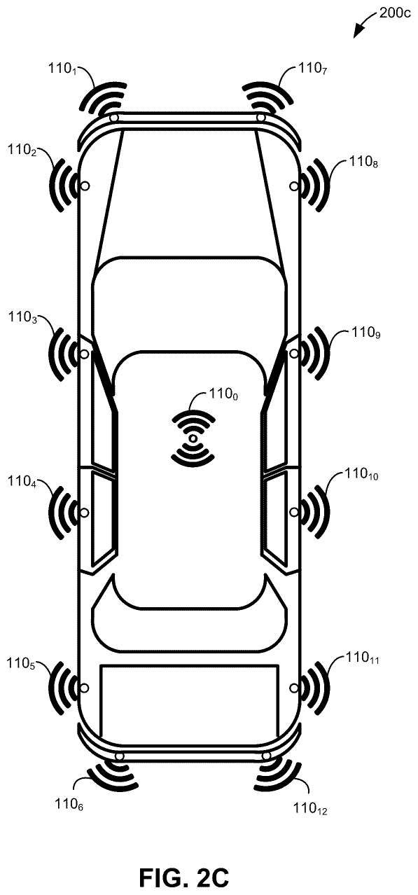

FIG. 1A is a block diagram illustrating an example system 100a including a host controller 102 and a plurality of Bluetooth low energy (BLE) anchors 110₀ to 110_{Y}, where “Y” is any suitable number (e.g., 5, 6, 7, 8, 9, 10, 11, 12, or more) of anchors. The host controller 102 is communicatively coupled to the plurality of BLE anchors 110₀ to 110_{Y} through a communication path 104, such as a bus (e.g., controller area network (CAN) bus, 10Base-T1S bus, universal asynchronous receiver/transmitter (UART) bus, etc.). The plurality of BLE anchors 110₀ to 110_{Y} may include a central BLE anchor 110₀, a first group of BLE anchors 110₁ to 110_{X}, where “X” is any suitable number (e.g., 2, 3, 4, 5, 6 or more) of anchors, and a second group of BLE anchors 110_{X+1} to 110_{Y}. In some examples, the plurality of BLE anchors 110₀ to 110_{Y} may include a single group of BLE anchors or more than two groups of BLE anchors, such as three, four, or more groups. In some examples, each group of BLE anchors may be arranged on a different side of a vehicle as further described below with reference to FIGS. 2A-2C.

Host controller 102 may include a microcontroller unit (MCU), central processing unit (CPU), or other suitable logic circuitry for managing operations (e.g., advertising, scanning, establishing connections, etc.) between the plurality of BLE anchors 110₀ to 110_{Y}. The host controller 102 may assign each BLE anchor 110₀ to 110_{Y} to a group and may schedule advertising and scanning within each group and between the groups. In some examples, the central BLE anchor 110₀ may manage communications between the host controller 102 and the plurality of BLE anchors 110₀ to 110_{Y}. In some examples, the central BLE anchor 110₀ may also manage (in place of or in addition to host controller 102) operations (e.g., advertising, scanning, establishing connections, etc.) between the plurality of BLE anchors 110₀ to 110_{Y}. As such, the central BLE anchor 110₀ may assign each BLE anchor 110₁ to 110_{Y} to a group and may schedule advertising and scanning within each group and between the groups as further described below.

FIG. 1B is a block diagram illustrating an example system 100b including the host controller 102 and the plurality of BLE anchors 110₀ to 110_{Y} as previously described and illustrated with reference to FIG. 1A. In addition, system 100b also includes users 118₁ and 118₂. Each user 118₁ and 118₂ possesses a user device 120₁ and 120₂, respectively. In this example, user 118₁ possesses a smart phone 120₁, and user 118₂ possesses a key fob 120₂. Each BLE anchor 110₀ to 110_{Y} may be connected to up to a plurality of user devices (e.g., 120₁, 120₂, others) using Bluetooth low energy (LE) asynchronous connection-oriented logical (ACL) links, which are referred to herein as active BLE connections. In an active BLE connection, a BLE anchor receives transmissions (e.g., packets) from a user device and responds to the transmissions. All BLE anchors 110₀ to 110_{Y} within the system may use the same Bluetooth device address, such that the user devices (e.g., 120₁, 120₂) see a single Bluetooth device (e.g., all the BLE anchors 110₀ to 110_{Y} appear as a single Bluetooth device from the perspective of the user devices).

Upon a user device (e.g., 120₁, 120₂) coming within range (e.g., within radio frequency (RF) range) of a BLE anchor 110₀ to 110_{Y}, the BLE anchor may discover the user device and establish an active BLE connection to the user device. Each group of anchors (e.g., 110₁ to 110_{X}, 110_{X+1} to 110_{Y}) may have an advertising and scanning schedule such that within each group, the BLE anchors advertise sequentially according to an anchor advertising interval for the respective group and scan sequentially according to an anchor scan interval for the respective group. By scheduling advertising and scanning within each group of BLE anchors, power consumption and the probability of collisions may be reduced compared to the power consumption and the probability of collisions if all the BLE anchors 110₀ to 110_{Y} are advertising simultaneously and/or all the BLE anchors 110₀ to 110_{Y} are scanning simultaneously.

In this example with two groups (e.g., 110₁ to 110_{X} and 110_{X+1} to 110_{Y}), user device 120₁ (e.g., phone) may scan while BLE anchors 110₁ to 110_{X} each advertise one at a time in sequence during a first anchor advertising interval (e.g., each BLE anchor 110₁ to 110_{X} advertises once during each first anchor advertising interval) and BLE anchors 110_{X+1} to 110_{Y} each advertise one at a time in sequence during a second anchor advertising interval (e.g., each BLE anchor 110_{X+1} to 110_{Y} advertises once during each second anchor advertising interval). In some examples, the first anchor advertising interval may equal the second anchor advertising interval (e.g., where X−1 equals Y−X+1), or the first anchor advertising interval may be different from the second anchor advertising interval (e.g., where X−1 does not equal Y−X+1). In this way, user device 120₁ may implement a scan simultaneously with the advertising of one of the BLE anchors 110₁ to 110_{Y} (e.g., one of BLE anchors 110₁ to 110_{X} if user 118₁ is approaching and/or near BLE anchors 110₁ to 110_{X} or one of BLE anchors 110_{X+1} to 110_{Y} if user 118₁ is approaching and/or near BLE anchors 110_{X+1} to 110_{Y}) and establish an active BLE connection with the corresponding BLE anchor.

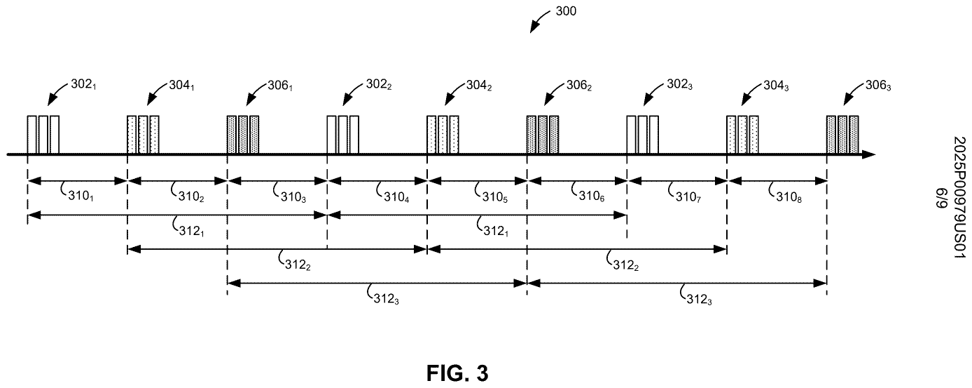

The first anchor advertising interval and the second anchor advertising interval may be based on the number of BLE anchors within the respective group and a selected interval between advertisements within the respective group. For example, for a group of BLE anchors including two BLE anchors and a selected interval of 42.5 milliseconds between advertisements within the group, the anchor advertising interval may be two times 42.5 milliseconds, which is 85 milliseconds. For a group of BLE anchors including three BLE anchors and a selected interval of 42.5 milliseconds between advertisements within the group, the anchor advertising interval may be three times 42.5 milliseconds, which is 127.5 milliseconds. Likewise, for a group of BLE anchors including four BLE anchors and a selected interval of 42.5 milliseconds between advertisements within the group, the anchor advertising interval may be four times 42.5 milliseconds, which is 170 milliseconds, etc. Accordingly in this example, each BLE anchor within a corresponding group of BLE anchors (e.g., 110₁ to 110_{X}, 110_{X+1} to 110_{Y}) advertises each anchor advertising interval, such that a different BLE anchor within the corresponding group advertises every 42.5 milliseconds as further described below with reference to FIG. 3.

User device 120₂ (e.g., key fob) may advertise while BLE anchors 110₁ to 110_{X} each scan one at a time in sequence during a first anchor scan interval (e.g., each BLE anchor 110₁ to 110_{X} scans once during each first anchor scan interval) and BLE anchors 110_{X+1} to 110_{Y} each scan one at a time in sequence during a second anchor scan interval (e.g., each BLE anchor 110_{X+1} to 110_{Y} scans once during each second anchor scan interval). In some examples, the first anchor scan interval may equal the second anchor scan interval (e.g., where X-1 equals Y-X+1), or the first anchor scan interval may be different from the second anchor scan interval (e.g., where X-1 does not equal Y-X+1). In this way, user device 120₂ may implement an advertisement simultaneously with the scan of one of the BLE anchors 110₁ to 110_{Y} (e.g., one of BLE anchors 110₁ to 110_{X} if user 118₂ is approaching and/or near BLE anchors 110₁ to 110_{X} or one of BLE anchors 110_{X+1} to 110_{Y} if user 118₂ is approaching and/or near BLE anchors 110_{X+1} to 110_{Y}) and establish an active BLE connection with the corresponding BLE anchor.

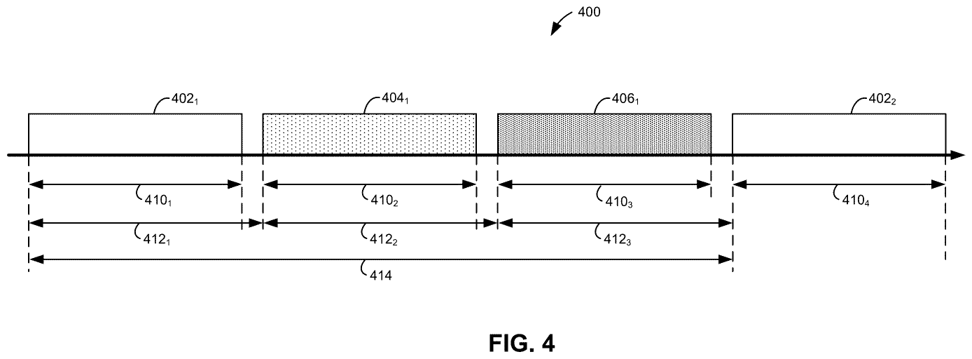

The first anchor scan interval and the second anchor scan interval may be based on the number of BLE anchors within the respective group and a selected group scan interval. For example, for a group of BLE anchors including two BLE anchors and a selected group scan interval of 100 milliseconds, the anchor scan interval may be two times 100 milliseconds, which is 200 milliseconds. For a group of BLE anchors including three BLE anchors and a selected group scan interval of 100 milliseconds, the anchor scan interval may be three times 100 milliseconds, which is 300 milliseconds. Likewise, for a group of BLE anchors including four BLE anchors and a selected group scan interval of 100 milliseconds, the anchor scan interval may be four times 100 milliseconds, which is 400 milliseconds, etc. Accordingly in this example, each BLE anchor within a corresponding group of BLE anchors scans each anchor scan interval, such that a different BLE anchor within the group scans every 100 milliseconds as further described below with reference to FIG. 4.

While system 100b includes two users 118₁ and 118₂ each possessing a single user device 120₁ and 120₂, respectively, in some examples, system 100b may include a single user or more than two users, and each user may possess more than one user device (e.g., smart phone, smart watch, key fob, etc.).

FIG. 2A is a schematic diagram illustrating an example vehicle 200 a including BLE anchors 110₀ to 110₄ (e.g., X=2, Y=4 in FIGS. 1A and 1B). BLE anchors 110₀ to 110₄ are communicatively coupled to a host controller 102 (not shown in FIG. 2A) as previously described and illustrated with reference to FIGS. 1A and 1B. Central BLE anchor 110₀ may be arranged within the vehicle 202a at a central location. BLE anchors 110₁ and 110₂ may be arranged on a first side (e.g., driver side) of the vehicle 200a, and BLE anchors 110₃ and 110₄ may be arranged on a second side (e.g., passenger side) of the vehicle 200a opposite to the first side. While vehicle 200a includes five BLE anchors in the example illustrated in FIG. 2A, in some examples, vehicle 200a may include more than five BLE anchors (e.g., 6, 7, 8, or more).

BLE anchors 110₁ and 110₂ may form a first group of BLE anchors, and BLE anchors 110₃ and 110₄ may form a second group of BLE anchors. In some examples, central BLE anchor 110₀ may not advertise or scan, while BLE anchors 110₁ and 110₂ may each advertise sequentially according to a first anchor advertising interval, and BLE anchors 110₃ and 110₄ may each advertise sequentially according to a second anchor advertising interval. In addition, BLE anchors 110₁ and 110₂ may each scan sequentially according to a first anchor scan interval, and BLE anchors 110₃ and 110₄ may each scan sequentially according to a second anchor scan interval. In this example, since the first group of BLE anchors and the second group of BLE anchors both include two BLE anchors, the first anchor advertising interval may equal the second anchor advertising interval, and the first anchor scan interval may equal the second anchor scan interval.

Accordingly, as a user (e.g., 118₁, 118₂ of FIG. 1B) possessing a user device (e.g., 120₁, 120₂ of FIG. 1B) approaches the driver side of the vehicle 200a, at least one of the BLE anchors 110₁ and 110₂ will be currently scanning/advertising simultaneously with the user device advertising/scanning such that the user device may be discovered and a connection can be established between the user device and the vehicle 200a. As a user (e.g., 118₁, 118₂) possessing a user device (e.g., 120₁, 120₂) approaches the passenger side of the vehicle 200a, at least one of the BLE anchors 110₃ and 110₄ will be currently scanning/advertising simultaneously with the user device advertising/scanning such that the user device may be discovered and a connection can be established between the user device and the vehicle 200a.

FIG. 2B is a schematic diagram illustrating an example vehicle 200 b including BLE anchors 110₀ to 110₈ (e.g., X=4, Y=8 in FIGS. 1A and 1B). BLE anchors 110₀ to 110₈ are communicatively coupled to a host controller 102 (not shown in FIG. 2B) as previously described and illustrated with reference to FIGS. 1A and 1B. Central BLE anchor 110₀ may be arranged within the vehicle 200b at a central location. BLE anchor 110₁ may be arranged on a first side (e.g., front side) of the vehicle 200b, BLE anchors 110₂ to 110₄ may be arranged on a second side (e.g., driver side) of the vehicle 200b, BLE anchors 110₅ to 110₇ may be arranged on a third side (e.g., passenger side) of the vehicle 200b opposite to the second side, and BLE anchor 110₈ may be arranged on a fourth side (e.g., rear side) of the vehicle 200b opposite to the first side. While vehicle 200b includes nine BLE anchors in the example illustrated in FIG. 2B, in some examples, vehicle 200b may include more than nine BLE anchors (e.g., 10, 11, 12, or more).

BLE anchor 110₁ may form a first group of BLE anchors, BLE anchors 110₂ to 110₄ may form a second group of BLE anchors, BLE anchors 110₅ to 110₇ may form a third group of BLE anchors, and BLE anchor 110₈ may form a fourth group of BLE anchors. In some examples, central BLE anchor 110₀ may not advertise or scan, while BLE anchor 110₁ may advertise according to a first anchor advertising interval, BLE anchors 110₂ to 110₄ may each advertise sequentially according to a second anchor advertising interval, BLE anchors 110₅ to 110₇ may each advertise sequentially according to a third anchor advertising interval, and BLE anchor 110₈ may advertise according to a fourth anchor advertising interval. In addition, BLE anchor 110₁ may scan according to a first anchor scan interval, BLE anchors 110₂ to 110₄ may each scan sequentially according to a second anchor scan interval, BLE anchors 110₅ to 110₇ may each scan sequentially according to a third anchor scan interval, and BLE anchor 110₈ may scan according to a fourth anchor scan interval.

In this example, since the first group of BLE anchors and the fourth group of BLE anchors both include one BLE anchor, the first anchor advertising interval may equal the fourth anchor advertising interval, and the first anchor scan interval may equal the fourth anchor scan interval. Since the second group of BLE anchors and the third group of BLE anchors both include three BLE anchors, the second anchor advertising interval may equal the third anchor advertising interval, and the second anchor scan interval may equal the third anchor scan interval. Since the first and fourth groups of BLE anchors each include one BLE anchor and the second and third groups of BLE anchors each include three BLE anchors, the second and third anchor advertising intervals may equal three times the first and fourth anchor advertising intervals, and the second and third anchor scan intervals may equal three times the first and fourth anchor scan intervals.

Accordingly, as a user (e.g., 118₁, 118₂ of FIG. 1B) possessing a user device (e.g., 120₁, 120₂ of FIG. 1B) approaches the front side of the vehicle 200b, the BLE anchor 110₁ will be currently scanning/advertising simultaneously with the user device advertising/scanning such that the user device may be discovered and a connection can be established between the user device and the vehicle 200b. As a user (e.g., 118₁, 118₂) possessing a user device (e.g., 120₁, 120₂) approaches the driver side of the vehicle 200b, at least one of the BLE anchors 110₂ to 110₄ will be currently scanning/advertising simultaneously with the user device advertising/scanning such that the user device may be discovered and a connection can be established between the user device and the vehicle 200b. As a user (e.g., 118₁, 118₂) possessing a user device (e.g., 120₁, 120₂) approaches the passenger side of the vehicle 200b, at least one of the BLE anchors 110₅ to 110₇ will be currently scanning/advertising simultaneously with the user device advertising/scanning such that the user device may be discovered and a connection can be established between the user device and the vehicle 200b. As a user (e.g., 118₁, 118₂) possessing a user device (e.g., 120₁, 120₂) approaches the rear side of the vehicle 200b, the BLE anchor 110₈ will be currently scanning/advertising simultaneously with the user device advertising/scanning such that the user device may be discovered and a connection can be established between the user device and the vehicle 200b.

FIG. 2C is a schematic diagram illustrating an example vehicle 200c including BLE anchors 110₀ to 110₁₂ (e.g., X=6, Y=12 in FIGS. 1A and 1B). BLE anchors 110₀ to 110₁₂ are communicatively coupled to a host controller 102 (not shown in FIG. 2C) as previously described and illustrated with reference to FIGS. 1A and 1B. Central BLE anchor 110₀ may be arranged within the vehicle 200c at a central location. BLE anchors 110₁ and 110₇ may be arranged on a first side (e.g., front side) of the vehicle 200c. BLE anchors 110₂ to 110₅ may be arranged on a second side (e.g., driver side) of the vehicle 200c. BLE anchors 110₈ to 110₁₁ may be arranged on a third side (e.g., passenger side) of the vehicle 200c opposite to the second side. BLE anchors 110₆ and 110₁₂ may be arranged on a fourth side (e.g., rear side) of the vehicle 200c opposite to the first side. While vehicle 200c includes thirteen BLE anchors in the example illustrated in FIG. 2C, in some examples, vehicle 200c may include more than thirteen BLE anchors (e.g., 14, 15, 16, or more).

In some examples, BLE anchors 110₁ and 110₇ may form a first group of BLE anchors, BLE anchors 110₂ to 110₅ may form a second group of BLE anchors, BLE anchors 110₈ to 110₁₁ may form a third group of BLE anchors, and BLE anchors 110₆ and 110₁₂ may form a fourth group of BLE anchors. In some examples, central BLE anchor 110₀ may not advertise or scan, while BLE anchors 110₁ and 110₇ may each advertise sequentially according to a first anchor advertising interval, BLE anchors 110₂ to 110₅ may each advertise sequentially according to a second anchor advertising interval, BLE anchors 110₈ to 110₁₁ may each advertise sequentially according to a third anchor advertising interval, and BLE anchors 110₆ and 110₁₂ may each advertise sequentially according to a fourth anchor advertising interval. In addition, BLE anchors 110₁ and 110₇ may each scan sequentially according to a first anchor scan interval, BLE anchors 110₂ to 110₅ may each scan sequentially according to a second anchor scan interval, BLE anchors 110₈ to 110₁₁ may each scan sequentially according to a third anchor scan interval, and BLE anchors 110₆ and 110₁₂ may each scan sequentially according to a fourth anchor scan interval.

In this example, since the first group of BLE anchors and the fourth group of BLE anchors both include two BLE anchors, the first anchor advertising interval may equal the fourth anchor advertising interval, and the first anchor scan interval may equal the fourth anchor scan interval. Since the second group of BLE anchors and the third group of BLE anchors both include four BLE anchors, the second anchor advertising interval may equal the third anchor advertising interval, and the second anchor scan interval may equal the third anchor scan interval. Since the first and fourth groups of BLE anchors each include two BLE anchors and the second and third groups of BLE anchors each include four BLE anchors, the second and third anchor advertising intervals may equal two times the first and fourth anchor advertising intervals, and the second and third anchor scan intervals may equal two times the first and fourth anchor scan intervals.

Accordingly, as a user (e.g., 118₁, 118₂ of FIG. 1B) possessing a user device (e.g., 120₁, 120₂ of FIG. 1B) approaches the front side of the vehicle 200c, at least one of the BLE anchors 110₁ and 110₇ will be currently scanning/advertising simultaneously with the user device advertising/scanning such that the user device may be discovered and a connection can be established between the user device and the vehicle 200c. As a user (e.g., 118₁, 118₂) possessing a user device (e.g., 120₁, 120₂) approaches the driver side of the vehicle 200c, at least one of the BLE anchors 110₂ to 110₅ will be currently scanning/advertising simultaneously with the user device advertising/scanning such that the user device may be discovered and a connection can be established between the user device and the vehicle 200c. As a user (e.g., 118₁, 118₂) possessing a user device (e.g., 120₁, 120₂) approaches the passenger side of the vehicle 200c, at least one of the BLE anchors 110₈ to 110₁₁ will be currently scanning/advertising simultaneously with the user device advertising/scanning such that the user device may be discovered and a connection can be established between the user device and the vehicle 200c. As a user (e.g., 118₁, 118₂) possessing a user device (e.g., 120₁, 120₂) approaches the rear side of the vehicle 200c, at least one of the BLE anchors 110₆ and 110₁₂ will be currently scanning/advertising simultaneously with the user device advertising/scanning such that the user device may be discovered and a connection can be established between the user device and the vehicle 200c.

In some examples, the BLE anchors 110₁ to 110₁₂ may be grouped differently. For example, BLE anchors 110₁ to 110₃ may form a first group of BLE anchors, BLE anchors 110₄ to 110₆ may form a second group of BLE anchors, BLE anchors 110₇ to 110₉ may form a third group of BLE anchors, and BLE anchor 110₁₀ to 110₁₂ may form a fourth group of BLE anchors. In other examples, BLE anchors 110₁ and 110₂ may form a first group of BLE anchors, BLE anchors 110₃ and 110₄ may form a second group of BLE anchors, BLE anchors 110₅ and 110₆ may form a third group of BLE anchors, BLE anchors 110₇ and 110₈ may form a fourth group of BLE anchors, BLE anchors 110₉ and 110₁₀ may form a fifth group of BLE anchors, and BLE anchors 110₁₁ and 110₁₂ may form a sixth group of BLE anchors. In other examples, other suitable groupings of BLE anchors 110₁ to 110₁₂ may be used. In any case, within each group of BLE anchors, advertising and scanning is implemented sequentially according to an anchor advertising interval and an anchor scan interval for the group, respectively, such that the frequency and duty cycle of advertising and the frequency and duty cycle of scanning is sufficient to discover a user device and establish a connection to the user device while reducing power consumption and the probability of collisions.

FIG. 3 is a timing diagram 300 illustrating an example method for a group of BLE anchors to each advertise sequentially according to an anchor advertising interval. In this example, the group of BLE anchors includes three BLE anchors, such as BLE anchors 110₂ to 110₄ or 110₅ to 110₇ of FIG. 2B. In FIG. 3, reference numerals 310₁ to 310₈ may collectively be referred to as a group advertising interval 310 and reference numerals 312₁ to 312₃ may be referred to as an anchor advertising interval 312. Advertising is scheduled among the three BLE anchors within the group such that a first BLE anchor (e.g., 110₂) within the group advertises as indicated at 302₁ according to the anchor advertising interval 312₁. After group advertising interval 310₁, a second BLE anchor (e.g., 110₃) within the group advertises as indicated at 304₁ according to the anchor advertising interval 312₂. After group advertising interval 310₂, a third BLE anchor (e.g., 110₄) within the group advertises as indicated at 306₁ according to the anchor advertising interval 312₃. After group advertising interval 310₃, the advertising of the three BLE anchors within the group repeats according to the anchor advertising intervals 312₁, 312₂, and 312₃ as indicated by advertisements 302₂, 304₂, 306₂, 302₃, 304₃, and 306₃ separated by group advertising intervals 310₄ to 310₈, respectively.

Each of the advertisements 302₁ to 302₃, 304₁ to 304₃, and 306₁ to 306₃ may include the transmission of packets on three primary channels. The packets may include information that can be used by user devices to identify the advertising device (e.g., vehicle access system), understand the capabilities of the advertising device, and initiate a connection. With a constant group advertising interval 310 and a constant anchor advertising interval 312, the advertisements 302₁ to 302₃, 304₁ to 304₃, and 306₁ to 306₃ from the BLE anchors within the group are transmitted at a constant frequency and duty cycle such that a user device scan will overlap with at least one of the advertisements from the group when the user device is within range of the group.

In the example illustrated in FIG. 3, the anchor advertising interval 312 is three times the group advertising interval 310, such that the first BLE anchor within the group advertises every anchor advertising interval as indicated at 312₁, the second BLE anchor within the group advertises every anchor advertising interval as indicated at 312₂, and the third BLE anchor within the group advertises every anchor advertising interval as indicated at 312₃. In some examples, the anchor advertising interval 312 may be 127.5 milliseconds such that the group advertising interval 310 is 42.5 milliseconds to meet the CCC DK specification. In some examples, the group advertising interval 310 is within a range between 42 milliseconds and 43 milliseconds. Each group of BLE anchors within a system may have a similar advertising schedule as shown in FIG. 3 (e.g., based on group advertising interval 310) depending upon the number of BLE anchors within the group. Therefore, the anchor advertising interval 312 for the group depends on the number of BLE anchors within the group. The larger the group, the larger the anchor advertising interval 312. The smaller the group, the smaller the anchor advertising interval 312. The anchor advertising interval 312 divided by the number of BLE anchors within the group defines the advertising frequency for the group. For a group of BLE anchors that includes a single BLE anchor (e.g., 110₁ of FIG. 2B), the anchor advertising interval 312 equals the group advertising interval 310. By synchronizing and scheduling advertising between BLE anchors within a group, in addition to reduced power consumption, the probability of collisions is also reduced.

FIG. 4 is a timing diagram 400 illustrating an example method for a group of BLE anchors to each scan sequentially according to an anchor scan interval. In this example, the group of BLE anchors includes three BLE anchors, such as BLE anchors 110₂ to 110₄ or 110₅ to 110₇ of FIG. 2B. In FIG. 4, reference numerals 410₁ to 410₄ may collectively be referred to as an anchor scan period 410 (or scan window), reference numerals 412₁ to 412₃ may collectively be referred to as a group scan interval 412, and reference numeral 414 may be referred to as an anchor scan interval. Scanning is scheduled among the three BLE anchors within the group such that a first BLE anchor (e.g., 110₂) within the group scans as indicated at 402₁ for an anchor scan period 410₁ according to the anchor scan interval 414. After group scan interval 412₁, a second BLE anchor (e.g., 110₃) within the group scans as indicated at 404₁ for an anchor scan period 410₂ according to the anchor scan interval 414. After group scan interval 412₂, a third BLE anchor (e.g., 110₄) within the group scans as indicated at 406₁ for an anchor scan period 410₃ according to the anchor scan interval 414. After group scan interval 410₃, the scanning of the three BLE anchors within the group repeats according to the anchor scan interval 414 as indicated by scan 402₂ for an anchor scan period 410₄.

Each of the scans 402_{1,} 404₁, 406₁, 402₂, etc. by the BLE anchors within the group may include searching for a user device (e.g., key fob) by listening for advertising packets. With a constant anchor scan period 410, a constant group scan interval 412, and a constant anchor scan interval 414, the scans 402_{1,} 404₁, 406₁, 402₂, etc. of the BLE anchors within the group are implemented at a constant frequency and duty cycle such that a user device advertisement will overlap with at least one of the scans from the group when the user device is within range of the group.

In the example illustrated in FIG. 4, the anchor scan interval 414 is three times the group scan interval 412, such that the first BLE anchor within the group scans every anchor scan interval as indicated at 414, the second BLE anchor within the group scans every anchor scan interval 414, and the third BLE anchor within the group scans every anchor scan interval 414. In some examples, the anchor scan interval 414 may be 300 milliseconds such that each group scan interval 412 is 100 milliseconds. The anchor scan period 410 may be less than or equal to the group scan interval 412. Each group of BLE anchors within a system may have a similar scanning schedule as shown in FIG. 4 (e.g., based on group scan interval 412) depending upon the number of BLE anchors within the group. Therefore, the anchor scan interval 414 for the group depends on the number of BLE anchors within the group. The larger the group, the larger the anchor scan interval 414. The smaller the group, the smaller the anchor scan interval 414. The anchor scan interval 414 divided by the number of BLE anchors within the group defines the scan frequency for the group. For a group of BLE anchors that includes a single BLE anchor (e.g., 110₁ of FIG. 2B), the anchor scan interval 414 equals the group scan interval 412. By synchronizing and scheduling scanning between BLE anchors within a group, in addition to reduced power consumption, the probability of collisions is also reduced. For example, if two BLE anchors are scanning at the same time, both of the BLE anchors may receive a connectable advertising packet from a user device (e.g., key fob) at the same time. In response, both of the BLE anchors may try to establish a connection to the user device at the same time, which results in a high probability of a collision.

In some examples, each group of BLE anchors may both scan as illustrated in FIG. 4 and advertise as illustrated in FIG. 3. Advertising may have priority over scanning. Accordingly, if advertising and scanning are scheduled to occur at the same time for a selected BLE anchor, the selected BLE anchor may temporarily interrupt scanning to advertise and then resume scanning once the advertising is complete.

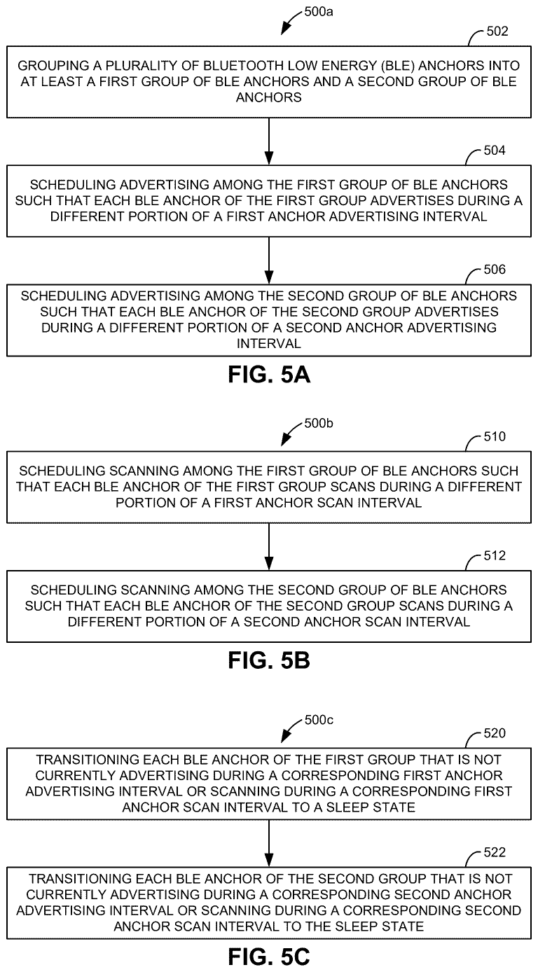

FIGS. 5A-5C are flow diagrams illustrating example methods 500a-500c for operating systems including BLE anchors. Methods 500a-500c may be implemented by a host controller 102 and BLE anchors 110₀ to 110_{Y} (FIGS. 1A-2C). In some examples, the methods 500a-500c may be implemented in hardware (e.g., logic circuits) of host controller 102 and/or BLE anchors 110₀ to 110_{Y} and/or by host controller 102 or BLE controllers of BLE anchors 110₀ to 110_{Y} executing machine readable instructions (e.g., software or firmware) stored in a non-transitory machine readable storage medium (e.g., memory).

As illustrated in FIG. 5A at 502, method 500a may include grouping a plurality of Bluetooth low energy (BLE) anchors (e.g., 110₀ to 110_{Y} of FIGS. 1A and 1B, 110₀ to 110₄ of FIG. 2A, 110₀ to 110₈ of FIG. 2B, 110₀ to 110₁₂ of FIG. 2C) into at least a first group of BLE anchors (e.g., 110₁ and 110₂ of FIG. 2A, 110₂ to 110₄ of FIG. 2B, 110₂ to 110₅ of FIG. 2C) and a second group of BLE anchors (e.g., 110₃ and 110₄ of FIG. 2A, 110₅ to 110₇ of FIG. 2B, 110₈ to 110₁₁ of FIG. 2C). In some examples, the plurality of BLE anchors may be grouped into a single group of BLE anchors. At 504, method 500a may include scheduling advertising among the first group of BLE anchors such that each BLE anchor of the first group advertises during a different portion of a first anchor advertising interval (e.g., 312 of FIG. 3). At 506, method 500a may include scheduling advertising among the second group of BLE anchors such that each BLE anchor of the second group advertises during a different portion of a second anchor advertising interval.

In some examples, method 500a of FIG. 5A may further include method 500b of FIG. 5B. As illustrated in FIG. 5B at 510, method 500b may include scheduling scanning among the first group of BLE anchors such that each BLE anchor of the first group scans during a different portion of a first anchor scan interval (e.g., 414 of FIG. 4). At 512, method 500b may include scheduling scanning among the second group of BLE anchors such that each BLE anchor of the second group scans during a different portion of a second anchor scan interval. In some examples, for each BLE anchor of the plurality of BLE anchors, scheduled advertising has priority over scheduled scans such that a scheduled advertising temporarily interrupts a scheduled scan.

In some examples, method 500b of FIG. 5B may further include method 500c of FIG. 5C. As illustrated in FIG. 5C at 520, method 500c may include transitioning each BLE anchor of the first group that is not currently advertising during a corresponding first anchor advertising interval or scanning during a corresponding first anchor scan interval to a sleep state. At 522, method 500c may include transitioning each BLE anchor of the second group that is not currently advertising during a corresponding second anchor advertising interval or scanning during a corresponding second anchor scan interval to the sleep state. By transitioning a BLE anchor that is not currently advertising or scanning to the sleep state, power consumption is reduced.

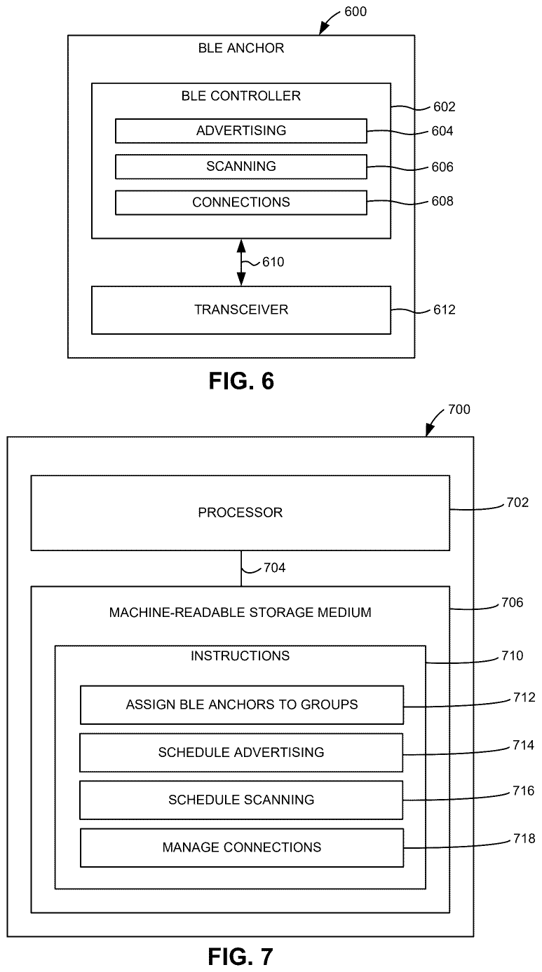

FIG. 6 is a block diagram illustrating an example BLE anchor 600. BLE anchor 600 may provide each BLE anchor 110₀ to 110_{Y} of FIGS. 1A and 1B (e.g.,. 110₀ to 110₄ of FIG. 2A, 110₀ to 110₈ of FIG. 2B, 110₀ to 110₁₂ of FIG. 2C). BLE anchor 600 includes a BLE controller 602 and a transceiver 612. BLE controller 602 is communicatively coupled to transceiver 612 through a communication path 610. When implemented within a BLE system (e.g., 100a of FIGS. 1A, 100b of FIGS. 1B, 200a of FIGS. 2A, 200b of FIGS. 2B, 200c of FIG. 2C), BLE controller 602 may be communicatively coupled to a plurality of BLE anchors (e.g., 110₀ to 110_{Y}) and a host controller (e.g., 102) via a bus (e.g., 104). BLE controller 602 controls the operations of BLE anchor 602 including transmitting and receiving packets via transceiver 612. Transceiver 612 includes an RF radio and antenna for transmitting and receiving packets using a BLE communication protocol. BLE controller 602 is also configured to implement advertising 604 (e.g., according to an advertising schedule generated by host controller 102 or central BLE anchor 110₀), implement scanning 606 (e.g., according to a scanning schedule generated by host controller 102 or central BLE anchor 110₀), and establish connections 608 (e.g., to user devices 120₁ and/or 120₂) as previously described with reference to FIGS. 1A-5C.

FIG. 7 is a block diagram illustrating an example processing system 700 for a host controller (e.g., 102 of FIGS. 1A and 1B) or central BLE anchor (e.g., 110₀ of FIGS. 1A-2C). In some examples, processing system 700 may perform the operations described with reference to FIGS. 5A-5C. Processing system 700 includes a processor 702 and a machine-readable storage medium 706. Processor 702 is communicatively coupled to machine-readable storage medium 706 through a communication path 704. Although the following description refers to a single processor and a single machine-readable storage medium, the description may also apply to a system with multiple processors and multiple machine-readable storage mediums. In such examples, the data and instructions may be distributed (e.g., stored) across multiple machine-readable storage mediums and the instructions may be distributed (e.g., executed by) across multiple processors.

Processor 702 includes one (i.e., a single) central processing unit (CPU) or microprocessor or more than one (i.e., multiple) CPU or microprocessor, and/or other suitable hardware devices for retrieval and execution of instructions stored in machine-readable storage medium 706. Processor 702 may fetch, decode, and execute instructions 712-718.

Processor 702 may fetch, decode, and execute instructions 712 to assign BLE anchors to groups (e.g., as described at least with reference to FIGS. 1A-2C). Processor 702 may fetch, decode, and execute instructions 714 to schedule advertising among the BLE anchors (e.g., as described at least with reference to FIG. 3). Processor 702 may fetch, decode, and execute instructions 716 to schedule scanning among the BLE anchors (e.g., as described at least with reference to FIG. 4). Processor 702 may fetch, decode, and execute instructions 718 to manage connections between the BLE anchors (e.g., 110₀ to 110_{Y}) and user devices (e.g., 120₁ and 120₂).

As an alternative or in addition to retrieving and executing instructions, processor 702 may include one (i.e., a single) electronic circuit or more than one (i.e., multiple) electronic circuit comprising a number of electronic components for performing the functionality of one of the instructions or more than one of the instructions in instruction memory 710 of machine-readable storage medium 706. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 706 is a non-transitory storage medium and may be any suitable electronic, magnetic, optical, or other physical storage device that stores executable instructions. Thus, machine-readable storage medium 706 may be, for example, a random access memory (RAM), an electrically-erasable programmable read-only memory (EEPROM), a storage drive, an optical disc, and the like. Machine-readable storage medium 706 may be disposed within an electronic device. In this case, the executable instructions may be installed on the electronic device. Alternatively, machine-readable storage medium 706 may be a portable, external, or remote storage medium that allows the electronic device to download the instructions from the portable/external/remote storage medium. In this case, the executable instructions may be part of an installation package.

It is to be understood that the features of the various exemplary embodiments described herein may be combined with each other, unless specifically noted otherwise.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. A system comprising:
a host controller; and
a plurality of Bluetooth low energy (BLE) anchors communicatively coupled to the host controller, the plurality of BLE anchors including at least a first group of BLE anchors,
wherein the first group of BLE anchors each advertise sequentially according to a first anchor advertising interval, and
wherein the first group of BLE anchors each scan sequentially according to a first anchor scan interval.

2. The system of claim 1, wherein the plurality of BLE anchors includes a second group of BLE anchors,
wherein the second group of BLE anchors each advertise sequentially according to a second anchor advertising interval, and
wherein the second group of BLE anchors each scan sequentially according to a second anchor scan interval.

3. The system of claim 2, wherein the first anchor advertising interval equals the second anchor advertising interval, and
wherein the first anchor scan interval equals the second anchor scan interval.

4. The system of claim 2, wherein the host controller is configured to schedule advertising and scanning among the first group of BLE anchors and to schedule advertising and scanning among the second group of BLE anchors.

5. The system of claim 2, wherein the plurality of BLE anchors includes a central BLE anchor, and
wherein the central BLE anchor is configured to schedule advertising and scanning among the first group of BLE anchors and to schedule advertising and scanning among the second group of BLE anchors.

6. The system of claim 2, wherein the plurality of BLE anchors includes a third group of BLE anchors,
wherein the third group of BLE anchors each advertise sequentially according to a third anchor advertising interval, and
wherein the third group of BLE anchors each scan sequentially according to a third anchor scan interval.

7. The system of claim 1, wherein the first anchor advertising interval and the first anchor scan interval are selected based on a number of BLE anchors within the first group.

8. The system of claim 7, wherein the first anchor advertising interval divided by the number of BLE anchors within the first group defines an advertising frequency for the first group, and
wherein the first anchor scan interval divided by the number of BLE anchors within the first group defines a scan frequency for the first group.

9. A vehicle comprising:
a host controller; and
a plurality of Bluetooth low energy (BLE) anchors communicatively coupled to the host controller, the plurality of BLE anchors including a central BLE anchor, a first group of BLE anchors, and a second group of BLE anchors,
wherein the first group of BLE anchors each advertise sequentially according to a first anchor advertising interval, and
wherein the second group of BLE anchors each advertise sequentially according to a second anchor advertising interval.

10. The vehicle of claim 9, wherein the first group of BLE anchors each scan sequentially according to a first anchor scan interval, and
wherein the second group of BLE anchors each scan sequentially according to a second anchor scan interval.

11. The vehicle of claim 9, wherein the central BLE anchor is arranged inside the vehicle.

12. The vehicle of claim 9, wherein the central BLE anchor does not advertise or scan.

13. The vehicle of claim 9, wherein the first group of BLE anchors are arranged on a first side of the vehicle and the second group of BLE anchors are arranged on a second side of the vehicle.

14. The vehicle of claim 9, wherein the first group of BLE anchors includes a first number of BLE anchors and the second group of BLE anchors includes a second number of BLE anchors equal to the first number.

15. The vehicle of claim 14, wherein the first anchor advertising interval divided by the first number is within a range between 42 milliseconds and 43 milliseconds.

16. The vehicle of claim 9, wherein the first group of BLE anchors includes a first number of BLE anchors and the second group of BLE anchors includes a second number of BLE anchors not equal to the first number.

17. A method comprising:
grouping a plurality of Bluetooth low energy (BLE) anchors into at least a first group of BLE anchors and a second group of BLE anchors;
scheduling advertising among the first group of BLE anchors such that each BLE anchor of the first group advertises during a different portion of a first anchor advertising interval; and
scheduling advertising among the second group of BLE anchors such that each BLE anchor of the second group advertises during a different portion of a second anchor advertising interval.

18. The method of claim 17, further comprising:
scheduling scanning among the first group of BLE anchors such that each BLE anchor of the first group scans during a different portion of a first anchor scan interval; and
scheduling scanning among the second group of BLE anchors such that each BLE anchor of the second group scans during a different portion of a second anchor scan interval.

19. The method of claim 18, further comprising:
transitioning each BLE anchor of the first group that is not currently advertising during a corresponding first anchor advertising interval or scanning during a corresponding first anchor scan interval to a sleep state; and
transitioning each BLE anchor of the second group that is not currently advertising during a corresponding second anchor advertising interval or scanning during a corresponding second anchor scan interval to the sleep state.

20. The method of claim 18, wherein, for each BLE anchor of the plurality of BLE anchors, scheduled advertising has priority over scheduled scans such that a scheduled advertising temporarily interrupts a scheduled scan.
